(19) United States
(12) Patent Application Publication
(10) Pub. No.: US 2008/0163077 A1
(43) Pub. Date: Jul. 3, 2008

(54) SYSTEM AND METHOD FOR VISUALLY GENERATING AN XQUERY DOCUMENT

(75) Inventors: CHUNG-I LEE, Tu-Cheng (TW); CHIEN-FA YEH, Tu-Cheng (TW); CHIU-HUA LU, Tu-Cheng (TW); WEI-QING XIAO, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignees: HONG FU PRECISION INDUSTRY (ShenZhen) CO., LTD., Shenzhen City (CN); HON HAI PRECISION INDUSTRY CO., LTD., Tu-Cheng (TW)

(21) Appl. No.: 11/930,169

(22) Filed: Oct. 31, 2007

(30) Foreign Application Priority Data
Dec. 29, 2006 (CN) 200610064603.3

(51) Int. Cl. G06F 3/00

(52) U.S. Cl. 715/760

(57) ABSTRACT

A computer-based method for visually generating an XQuery document include: opening a Web page, the Web page is an HTML document and consists of different basic components; converting the Web page into an HTML DOM; expressing the contents of the Web page with visually editable basic components; selecting needed basic components from the visually editable Web page; searching nodes corresponding to the selected basic components in the HTML DOM, searching parent nodes of the nodes by adopting a recursion method in the HTML DOM until a root node of the HTML DOM is obtained; generating XPath expressions of the selected basic components according to the nodes locations in the HTML DOM; incorporating the XPath expressions into an XQuery document according to relationship of the nodes locations corresponding to the XPath expressions in the HTML DOM. A system for visually generating an XQuery document is also disclosed.

### BACKGROUND OF THE INVENTION

1. Field of the Invention

The present invention relates to a system and method for visually generating an XQuery document.

2. Description of Related Art

W3C (World Wide Web Consortium) is working to make the Web accessible to all users (despite differences in culture, education, ability, resources, and physical limitations). W3C also coordinates its work with many other standards organizations such as the Internet Engineering Task Force, the Wireless Application Protocols (WAP) Forum, and the Unicode Consortium.

The W3C is possess of XML Path Language (XPath) Version 1.0 specification. XPath is used for converting a node in an HTML DOM into a Boolean, double or character string. The Document Object Model (DOM) is a platform language neutral Application Programming Interface (API) that allows programs to access and update the content, structure, and style of a document. The HTML Document Object Model (HTML DOM) defines a standard way for accessing and manipulating HTML documents.

XPath is designed to be used by XQuery. XQuery is a language for extracting data from HTML documents. In general, the XQuery documents are used to edit in text edit mode, which lead to burden greatly during querying Web. So, it is needed that a system and method for visually generating an Xquery document be provided.

### SUMMARY OF THE INVENTION

A system for visually generating an XQuery document includes: a document model creating module, a visually editing module, an XPath expression generating module, and an XQuery document generating module. The document model creating module is configured for converting a Web page into an HTML DOM; the visually editing module is configured for expressing contents of the Web page with visually editable basic components; the XPath expression generating module is configured for receiving a plurality of basic components selected by the user on the visually editable Web page, searching the nodes corresponding to the selected basic components in the HTML DOM, and searching parent nodes of the nodes by adopting a recursion method in the HTML DOM until a root node of the HTML DOM is obtained; the XPath expression generating module is further configured for generating XPath expressions of the selected basic components according to the locations of the nodes corresponding to the selected basic components in the HTML DOM; and the XQuery document generating module is configured for incorporating the XPath expressions in an XQuery document according to relationship of the XPath expressions locations in the HTML DOM.

A computer-based method for visually generating an XQuery document includes: opening a Web page, the Web page is an HTML document and consists of different basic components; converting the Web page into an HTML DOM; expressing the contents of the Web page with visually editable basic components; selecting needed basic components from the visually editable Web page; searching nodes corresponding to the selected basic components in the HTML DOM, searching parent nodes of the nodes by adopting a recursion method in the HTML DOM until a root node of the HTML DOM is obtained; generating XPath expressions of the selected basic components according to the nodes locations in the HTML DOM; incorporating the XPath expressions into an XQuery document according to relationship of the nodes locations corresponding to the XPath expressions in the HTML DOM.

### BRIEF DESCRIPTION OF THE DRAWINGS

FIG. 1 is a schematic diagram of function modules of a system for visually generating an XQuery document in accordance with a preferred embodiment;

FIG. 2 is a schematic diagram of representing a document tree (node tree) of an HTML document;

FIG. 3 is a flowchart of a method for visually generating an XQuery document in accordance with a preferred embodiment;

FIG. 4 is a schematic diagram of a visually editable Web page in accordance with a preferred embodiment; and

FIG. 5 shows a visually editable Web page and it's HTML DOM.

### DETAILED DESCRIPTION OF THE INVENTION

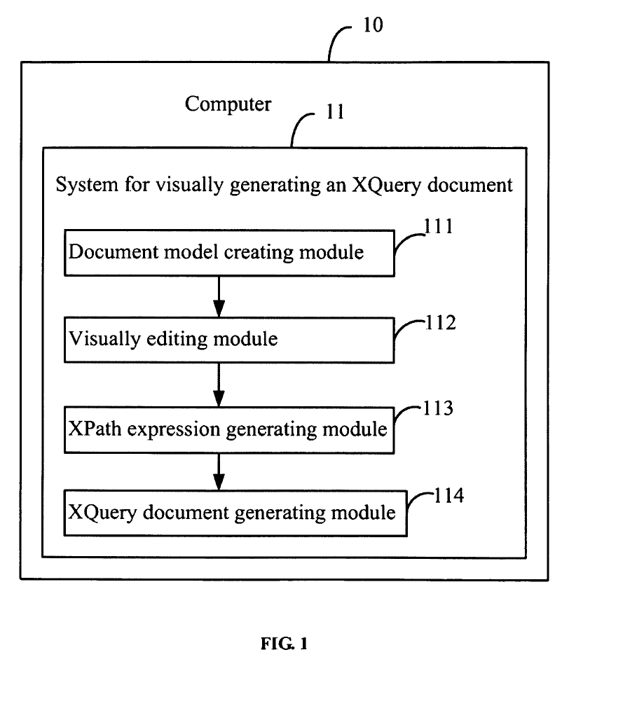

FIG. 1 is a schematic diagram of function modules of a system for visually generating an XQuery document (hereinafter, “the system 11”) in accordance with a preferred embodiment. The system 11 is typically installed on a computer 10. The computer 10 connects with the World Wide Web (WWW), and users can browse Web pages with the computer 10. The system 11 mainly includes a document model creating module 111, a visually editing module 112, an XPath expression generating module 113, and an XQuery document generating module 114.

The document model creating module 111 is configured for converting a Web page into an HTML DOM (Document Object Model, DOM) in accordance with HTML specifications. HTML stands for Hypertext Markup Language. The HTML specifications are a syntax rules and well known.

The HTML DOM defines a standard way for accessing and manipulating HTML documents. The Web page is in HTML format, i.e. the Web page is a typical HTML document. The Web page consists of different basic components. The basic components of the Web page include graphics, characters, texts, buttons, and multimedia files, etc.

The HTML DOM represents an HTML document as a tree-structure (a node tree), with elements, attributes, and text. Everything in an HTML document is a node. The entire document is a document node; every HTML tag is an element node; the contents contained in the HTML elements are text nodes; every HTML attribute is an attribute node; comments are comment nodes. All nodes in an HTML document form a document tree (node tree). The tree starts at the document node and continues to branch out until it has reached all text nodes at the lowest level of the tree.

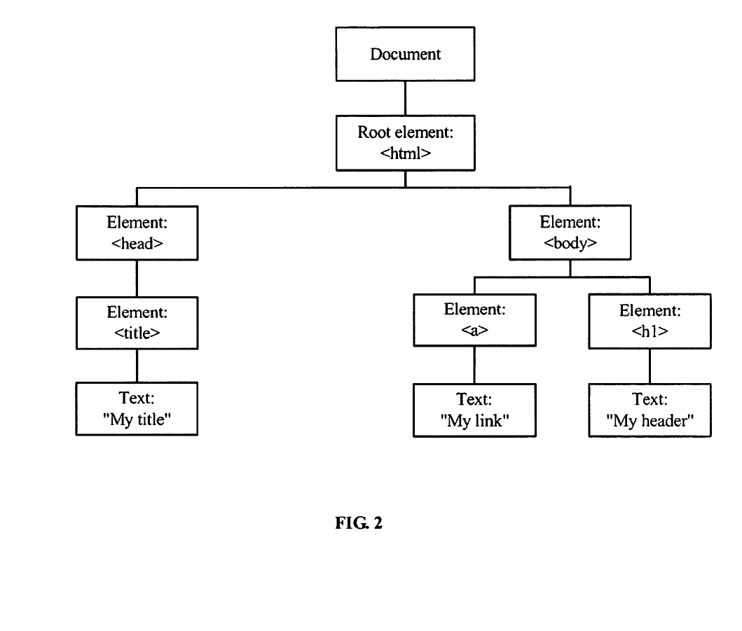

FIG. 2 represents a document tree (node tree) of an HTML document. All the nodes have relationships to each other. Every node except for the document node has a parent node. E.g. the parent node of the <head> and <body> nodes is the <html> node, and the parent node of the “My link” text node is the <a> node. Most element nodes have child nodes. E.g. the <head> node has one child node: the <title> node. The <title> node also has one child node: the text node “My title”. Nodes are siblings when they share a parent. E.g. the <h1> and <a> nodes are siblings, because their parent is the <body> node. Nodes can also have descendants. Descendants are all the nodes that are children of a node, or children of those children, and so on. E.g. all text nodes are descendants of the <html> node, while the first text node is descendant of the <head> node. Nodes can also have ancestors. Ancestors are nodes that are parents of a node, or parents of this parent, and so on. E.g. all text nodes have the <html> node as an ancestor.

Because the HTML data is structured in a tree form, it can be traversed without knowing the exact structure of the tree and without knowing the type of data contained within.

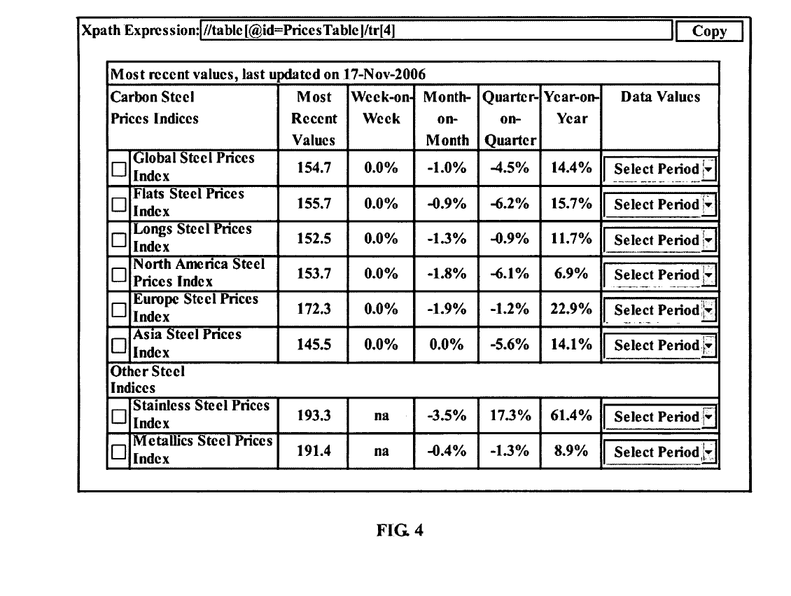

The visually editing module 112 is configured for expressing contents of the Web page with visually editable basic components. Referring to FIG. 4, a schematic diagram of a visually editable Web page in accordance with a preferred embodiment is showed.

The XPath expression generating module 113 is configured for receiving a plurality of basic components selected by the user on the visually editable Web page, searching the nodes corresponding to the selected basic components in the HTML DOM, and searching parent nodes of the nodes by adopting a recursion method in the HTML DOM until a root node of the HTML DOM is obtained.

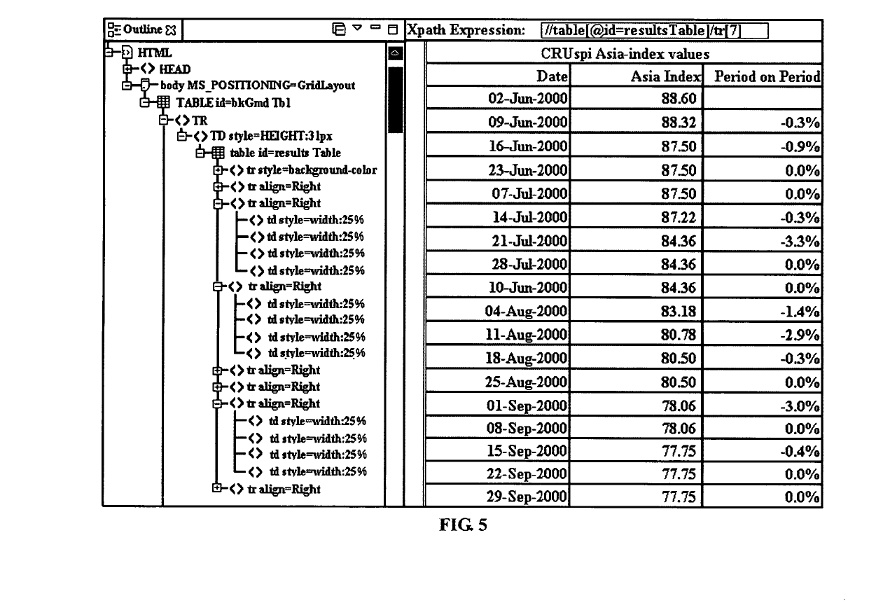

The XPath expression generating module 113 is further configured for generating XPath expressions of the selected basic components according to the locations of the nodes corresponding to the selected basic components in the HTML DOM. FIG. 5 shows a visually editable Web page and it's HTML DOM. On the visually editable Web page, the user selects a basic component, the XPath expression generating module 113 generates an XPath expression according to the node location in the HTML DOM corresponding to the selected basic component.

The XQuery document generating module 114 is configured for incorporating the XPath expressions in an XQuery document according to relationship of the XPath expressions locations in the HTML DOM.

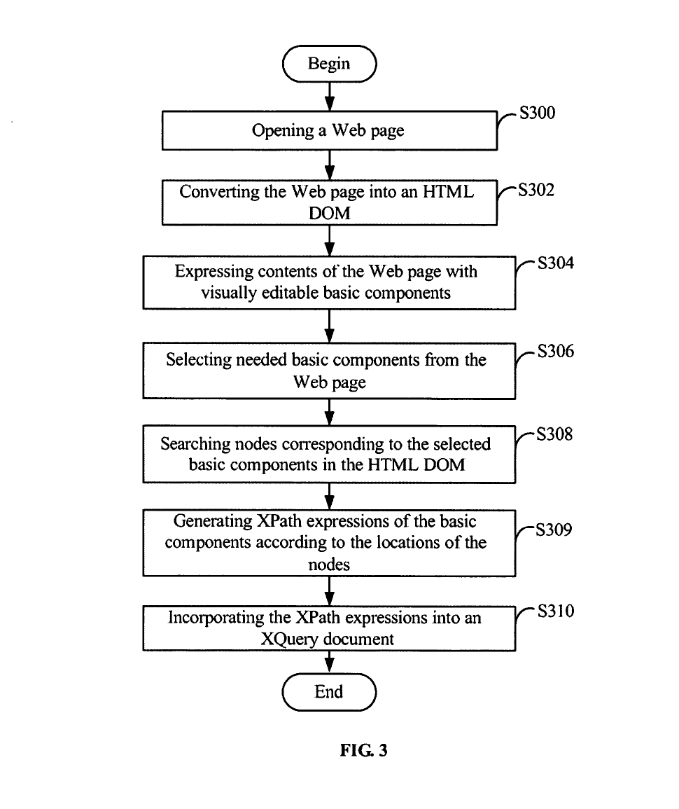

FIG. 3 is a flowchart of a method for visually generating an XQuery document in accordance with a preferred embodiment. In step S300, a user opens a Web page. The Web page is typically the HTML document and consists of the different basic components. In step S302, the document model creating module 111 converts the Web page into an HTML DOM in accordance with the HTML specifications.

In step S304, the visually editing module 112 expresses the contents of the Web page with visually editable basic components. Referring to FIG. 4, a schematic diagram of a visually editable Web page in accordance with the preferred embodiment is showed.

In step S306, the user selects needed basic components from the visually editable Web page.

In step S308, the XPath expression generating module 113 receives the selected basic components, searches nodes corresponding to the selected basic components in the HTML DOM, and searches parent nodes of the nodes by adopting a recursion method in the HTML DOM until a root node of the HTML DOM is obtained.

In step S309, the XPath expression generating module 113 generates XPath expressions of the selected basic components according to the nodes locations in the HTML DOM.

In step S310, the XQuery document generating module 114 incorporates the XPath expressions into an XQuery document according to relationship of the nodes locations corresponding to the XPath expressions in the HTML DOM.

It is to be understood, however, that even though numerous characteristics and advantages of the indicated invention have been set forth in the foregoing description, together with details of the structure and function of the invention, the disclosure is illustrative only and changes may be made in details, especially in matters of shape, size and arrangement of parts within the principles of the invention to the full extent indicated by the broad general meaning of the terms in which the appended claims are expressed.

What is claimed is:

1. A system for visually generating an XQuery document, the system being installed on a computer and comprising: a document model creating module, a visually editing module, an XPath expression generating module and an XQuery document generating module, wherein:
the document model creating module is configured for converting a Web page into an HTML DOM;
the visually editing module is configured for expressing contents of the Web page with visually editable basic components;
the XPath expression generating module is configured for receiving a plurality of basic components selected by the user on the visually editable Web page, searching the nodes corresponding to the selected basic components in the HTML DOM, and searching parent nodes of the nodes by adopting a recursion method in the HTML DOM until a root node of the HTML DOM is obtained;
the XPath expression generating module is further configured for generating XPath expressions of the selected basic components according to the locations of the nodes corresponding to the selected basic components in the HTML DOM; and
the XQuery document generating module is configured for incorporating the XPath expressions in an XQuery document according to relationship of the XPath expressions locations in the HTML DOM.

2. A computer-based method for visually generating an XQuery document, the method comprising:
opening a Web page, the Web page is an HTML document and consists of different basic components;
converting the Web page into an HTML DOM;
expressing the contents of the Web page with visually editable basic components;
selecting needed basic components from the visually editable Web page;
searching nodes corresponding to the selected basic components in the HTML DOM, searching parent nodes of the nodes by adopting a recursion method in the HTML DOM until a root node of the HTML DOM is obtained;
generating XPath expressions of the selected basic components according to the nodes locations in the HTML DOM;
incorporating the XPath expressions into an XQuery document according to relationship of the nodes locations corresponding to the XPath expressions in the HTML DOM.
